(19) United States
(12) Patent Application Publication
(10) Pub. No.: US 2004/0078592 A1
(43) Pub. Date: Apr. 22, 2004

(54) System and method for deploying honeypot systems in a network

(75) Inventors: Peter P. Fagone, West Orange, NJ (US); David Jon Hendrie, Morristown, NJ (US)

Correspondence Address: AT&T CORP., P.O. BOX 4110, MIDDLETOWN, NJ, 07748, US

(73) Assignee: AT & T Corp.

(21) Appl. No.: 10/272,581

(22) Filed: Oct. 16, 2002

(51) Int. Cl. H04L 9/00

(52) U.S. Cl. 713/201

(57) ABSTRACT

A honeypot architecture is disclosed with significant advantages over the prior art. Attacks are routed through a virtual private network to a honeypot system with limited controlled access to the public data networks.

### BACKGROUND OF INVENTION

The present invention relates to security in a computer network.

Protecting a computer network against unauthorized intrusion has proven more and more difficult over the years. A network administrator must remain vigilant against a vast array of security exploits that only grows from day to day. Traditional approaches to securing a computer network range from the deployment of intrusion detection systems to mechanisms for blocking unauthorized network traffic, i.e. though the use of a network traffic filter such as a “firewall.” Although such protective mechanisms are fundamental and critical to basic security procedure, it is almost always possible that such mechanisms can be circumvented given a persistent and knowledgeable attacker.

A recent development has been the deployment of what are referred to in the art as “honeypots.” A honeypot is a system designed to be susceptible to compromise by some potential unknown attacker. By monitoring the activity of an unauthorized intruder through a honeypot, a network administrator can identify tactics and tools used by the attacker, deceive and frustrate the attacker—without exposing a mission-critical system to attack. A straightforward approach to building a honeypot has been to merely construct a throwaway machine on a production network with some known security holes to lure attackers. See, e.g., Lance Spitzner, “How to Build a Honeypot,” 2000. Unfortunately, such a honeypot is very difficult to deploy and administer in a manner that does not compromise the security of other machines in the network. Another approach to building a honeypot has been to simulate a victim system: the complexity of the simulation ranges from the simple (scripts to emulate services with known security vulnerabilities) to the complicated (software for emulating an entire operating system or even a network of computers with different operating systems). See, e.g., e.g., Fred Cohen's “Deception Toolkit” (http://www.all.net/dtk/index.html); Network Associates' “Cybercop Sting” (http://www.pgp.com/products/cyber-cop-sting/default.asp); Recourse “Mantrap” (http://www.recourse.com/products/mantrap/man.html). Such approaches have distinct security advantages over a system that explicitly mirrors a production system—but also present the risk that the attacker will more readily see through the simulation and detect the nature of the honeypot.

Accordingly, there is a need for an improved honeypot architecture that is easier to deploy and administer in a secure fashion.

### SUMMARY OF INVENTION

The present invention is directed to a honeypot architecture with significant advantages over the prior art. In accordance with an embodiment of the invention, one or more honeypot systems are interconnected as a virtual private network with one or more target/customer networks. Attacks directed to a network address on the target network assigned to a honeypot system are routed through a virtual private network gateway to one of the honeypot systems. The honeypot system has limited access to the rest of the target network and/or any public data networks only through the virtual private network. Thus, the honeypot system may be readily deployed in a new customer network by simply adding a virtual private network gateway configured to forward appropriate traffic to the honeypot system network. The honeypot system advantageously need not be co-located with the customer network and may be maintained and carefully monitored by specialists as a service for the customer network. Even if the honeypot system is ultimately compromised, access to other machines can be limited in a controlled manner through proper configuration of the virtual private network.

These and other advantages of the invention will be apparent to those of ordinary skill in the art by reference to the following detailed description and the accompanying drawings.

### BRIEF DESCRIPTION OF DRAWINGS

FIG. 1 is an abstract illustration of a honeypot architecture, configured in accordance with an embodiment of the invention.

FIG. 2 is a flowchart of processing performed by a gateway in a customer network directing traffic to the honeypot infrastructure.

FIG. 3 is a more detailed illustration of a preferred embodiment of the architecture shown in FIG. 1.

FIG. 4 is a diagram illustrating the deployment of an aspect of the present invention.

### DETAILED DESCRIPTION

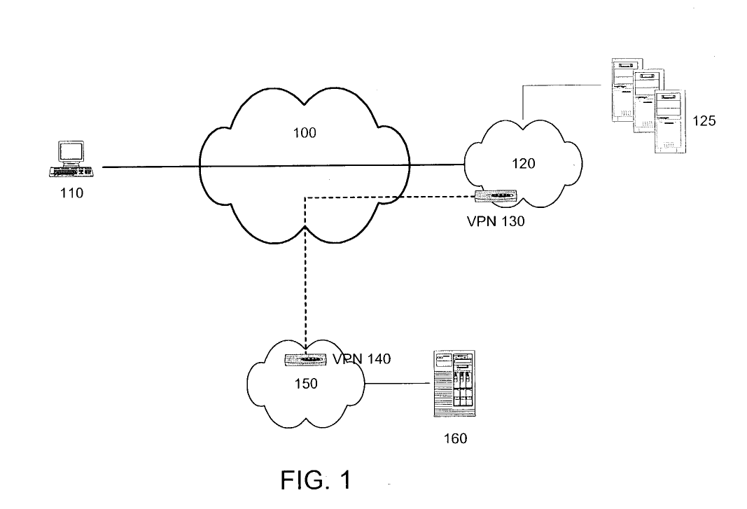

FIG. 1 is an abstract illustration of a honeypot architecture, configured in accordance with an embodiment of the invention. In FIG. 1, a public data network 100, such as the Internet or any other type of wide area network (WAN), provides public users with connectivity to a computer network 120, operated and maintained by some entity such as a corporation or organization. The computer network 120 can be, for example and without limitation, providing public access to a variety of server computers 125 such as a Web server. Or the computer network can be part of an Intranet/Extranet whose resources, although exposed to the public data network, are designed to only be accessible to certain remote authenticated clients. Computer network 120 can be a local area network or any other network architecture that permits for virtual private networking. Computer network 120 is not limited to any particular networking architecture; rather, computer network 120 is a network of computer resources that represents some potential target of some unknown attacker 110 with access to the public data network. Accordingly, the inventors refer to computer network 120 herein without limitation as the “target” network 120.

As is known in the art, the resources on the target network 120 are allocated network addresses which can be used by network hosts from across the public data network to address traffic intended for the target network 120. Accordingly, for example, where public data network 100 is a network utilizing the TCP/IP protocol suite, the resources accessible through the target network 120 are allocated Internet Protocol (IP) addresses, either globally or through some locally-administered network address translation process.

A subset of publicly-accessible network addresses in target network 120 are allocated to what are known in the art as “honeypot” systems, as referred to above. The network addresses allocated to the honeypot systems should not be advertised, e.g., by the domain name system or otherwise, or recognized as a publicly-accessible legitimate service. The honeypot systems can be, without limitation, custom-built machines configured to be compromised in a controlled fashion or can be based on existing commercial products such as Recourse Mantrap. In accordance with an aspect of the invention, however, the honeypot system 160, as shown in FIG. 1, is not deployed in a manner providing direct access to either the target network 120 or the public data network 100. Rather, a virtual private network is established between the honeypot system 160 and the target network 120. Illustrating this architecture in FIG. 1, a virtual private network gateway 130 in the target network 120 is shown providing connectivity to another virtual private network gateway 140. The second virtual private network gateway 140 can be connected directly to the honeypot system 160 or, as shown in FIG. 1, can be connected to a honeypot network 150 which provides connectivity to one or more honeypot systems 160. The virtual private network gateways 130, 140 can be implemented using any of a number of known commercial virtual private network solutions, both hardware and/or software-based. The gateways 130, 140 can ensure that traffic to and from the honeypot system 160 is tunneled through the virtual private network. Conventional tunneling protocols, such as L2TP, and security procedures, such as IPSec, can be utilized in routing packets between network 120 and network 150. The present invention is not limited to any particular virtual private network architectural solution. Accordingly, the virtual private gateway 140 shown in FIG. 1 can be implemented as a separate network component, or can be a software application executed on a gateway server or, less preferably, on the honeypot system 160 itself.

The honeypot system 160 advantageously need not even be co-located with any of the components of the rest of the target network 120. In fact, the honeypot system 160 and network 150 can be operated and maintained by specialists completely separate from the organization administering the target network 120. The honeypot system 160 can be operated as a service to the organization running the target network 120.

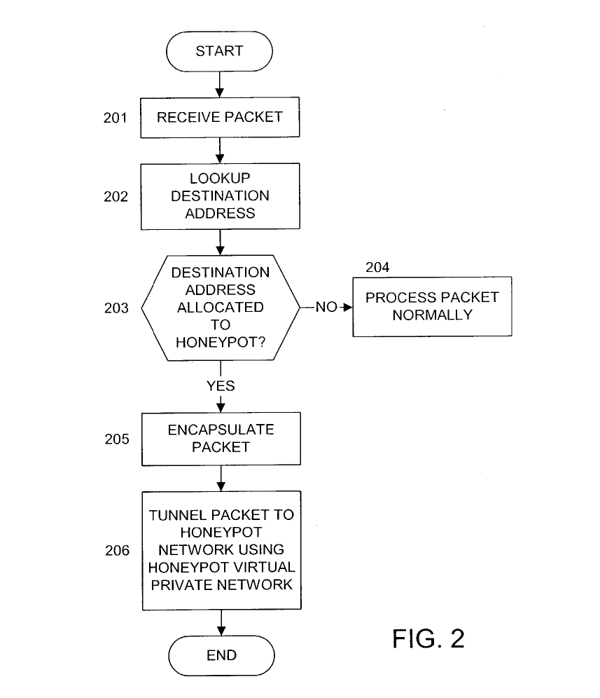

FIG. 2 is a flowchart of processing performed in the target network 120 to redirect traffic to the honeypot infrastructure. The processing can be performed, for example, at the virtual private network gateway 130 where target network 120 is a broadcast local area network. At step 201, a packet is received for processing from some source address in the public data network 100. At step 202, a lookup is conducted for the destination address of the packet to determine whether the destination address of the packet is one of the network addresses allocated to a honeypot system. If the network address is not allocated to a honeypot system, at step 203, then the packet can be processed normally by other elements in the target network 120, at step 204. If, however, the network address is allocated to a honeypot, then it is clear that the packet is not meant for legitimate purposes on the target network 120 and can, thus, be routed elsewhere. No legitimate traffic should be directed to the honeypot network address. The packet could be part of an attack or probe, or could be caused by some more innocuous reason. Regardless, if the destination address is allocated to a honeypot system, at step 203, then the packet is tunneled to the honeypot system at steps 205-206. This can be accomplished, for example, by encapsulating the packet using any of a number of known tunneling protocols and forwarding the packet to a corresponding virtual private network gateway in the honeypot network.

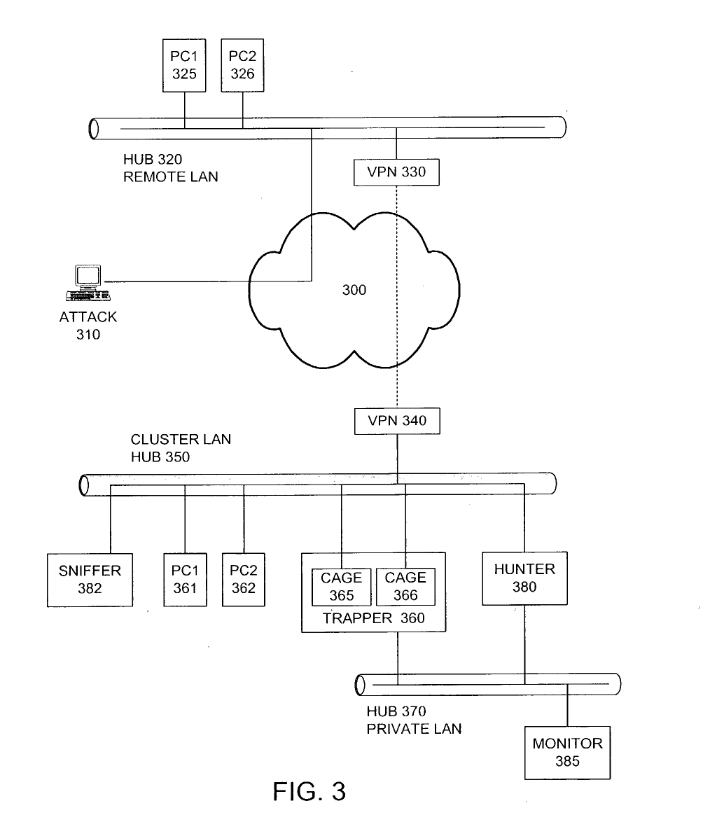

FIG. 3 sets forth a more detailed illustration of the honeypot architecture shown in FIG. 1, in accordance with a preferred embodiment of the invention. The target network 320 comprises a local area network with connectivity to the Internet/WAN 300 and to various server computers, e.g., computers 325, 326. A virtual private network gateway 330 is implemented in the local area network 320 which tunnels packets to virtual private network gateway 340. Virtual private network 340 provides access to the honeypot system network 350. Honeypot system network 350 is another local area network which provides connectivity to the honeypot trapper system 360. No production traffic should be found on the honeypot system network 350. The honeypot trapper system 360 is shown executing two “cage” applications which are designed to lure attackers in. A “hunter” application can be also provided, executing on a separate machine 380, to monitor and detect the activities of an attacker in compromising the honeypot cages 365, 366. It is advantageous to include, in addition to the detection mechanisms implemented in a hunter application, a packet sniffer 382 on the local area network to provide another record/log of any and all traffic entering and leaving the honeypot. It is also advantageous to provide a back-end private local area network 370 to specifically provide remote monitoring of the monitoring mechanisms in the honeypot itself. The back-end local area network 370 should be be designed to be private and should not route and/or participate in traffic to other network segments. Logs can be remotely dispatched through the local area network 370 which provides a back-channel where another monitoring system 385 can keep track of how the trapper system 360 and the hunter system 380 are doing. The honeypot architecture shown in FIG. 3 advantageously captures data in layers. The multiple layers of protection, data collection, and monitoring provide further security against attack once the honeypot is compromised. They also ensure that the honeypot can only be compromised in a controlled manner that will be detected by at least one of the mechanisms described above.

The virtual private network gateways 330, 340 can be readily configured to provide data containment for the compromised honeypot. It is advantageous to configure the virtual private network to allow all incoming traffic into the honeypot, but to restrict outgoing connections. Restricting all outbound connections would probably be too suspicious to lure any interested attackers; nevertheless, the number of permissible outbound connections should be limited to some number (such as between five and ten) in order to discourage use of the compromised honeypot as part of a larger denial-of-service attack. Unlike other honeypot architectures, this may be readily done through conventional configuration of the virtual private network. Moreover, if the honeypot is thoroughly compromised in a manner that renders it a danger to the rest of the networks, it may be readily disengaged from the rest of the networked universe by shutting down the virtual private network gateway 340. This functionality can, in fact, be built into the gateway itself to prevent the honeypot from being used as a platform for attacks against other networked systems.

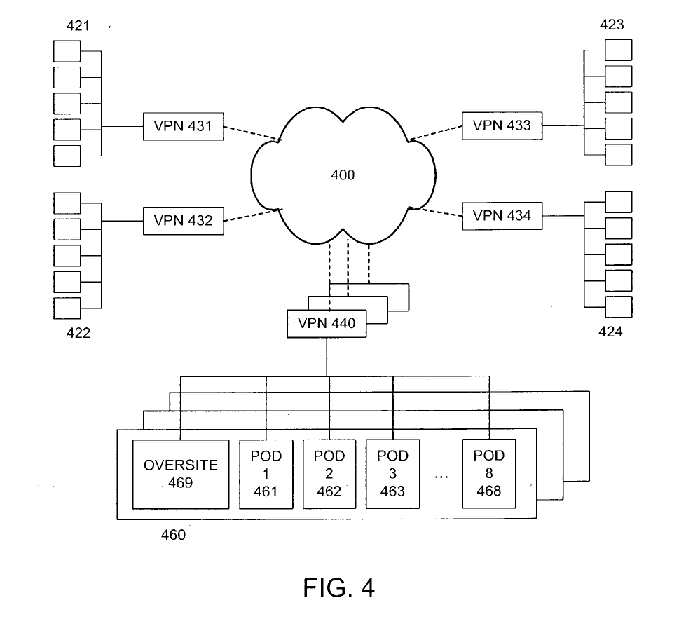

One of the advantages of the above-mentioned honeypot architecture is that a single facility monitored by security specialists can be quickly and readily deployed in a number of networks geographically dispersed across the Internet/WAN. As illustrated in FIG. 4, one or more honeypot systems 461, 462, 463, . . . 468 can be grouped as part of a cluster 460 with proper oversight systems 469. Each cluster 460 can have a virtual private network gateway 440 configured to provide connectivity with one or more other virtual private network gateways 431, 432, 433, 434 across the public data network 400. Multiple target networks 421, 422, 423, 424 administered by the same or different organizations can all be handled by a single cluster or by a number of different clusters, depending on the needs of the network administrators. A separate virtual private network can be established for each separate target network/customer, with the gateways sorting traffic to make sure that the correct traffic enters the correct tunnel to the correct network. By centralizing the management of the honeypot systems, the architecture reduces costs and ensures that the proper specialists can effectively monitor the safety and efficacy of the respective honeypot traps.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. For example, the detailed description describes an embodiment of the invention with particular reference to IP virtual private networking. However, the principles of the present invention could be readily extended to other protocols and networking approaches. Such an extension could be readily implemented by one of ordinary skill in the art given the above disclosure.

1. A method of deploying a honeypot system in one or more computer networks connected to a public data network, comprising the steps of:
establishing virtual private network connectivity between the honeypot system and the customer network which is configured to recognize a network address allocated to the honeypot system; and
receiving traffic addressed to the network address allocated to the honeypot system which is routed through the virtual private network to the honeypot system.

2. The method of claim 1 further comprising the step of forwarding traffic from the honeypot system only through the virtual private network.

3. The method of claim 2 wherein the traffic forwarded by the honeypot system through the virtual private network is limited to less than ten connections.

4. The method of claim 1 wherein the network address is an Internet Protocol address.

5. A device-readable medium storing program instructions for performing a method of deploying a honeypot system, the method comprising the steps of:
receiving traffic from a public data network;
determining whether the traffic is destined for a network address allocated to a honeypot system; and
where the traffic is destined for the network address allocated to the honeypot system, tunneling the traffic through a virtual private network to the honeypot system.

6. The device-readable medium of claim 5 wherein the network address is an Internet Protocol address.

7. A network architecture comprising:
one or more honeypot systems;
a local area network connecting the honeypot systems; and
a gateway providing virtual private network connectivity to another gateway in a computer network, where traffic from a public data network addressed to a network address allocated to the honeypot systems is routed through the virtual private network to the local area network connecting the honeypot systems.

8. The network architecture of claim 7 further comprising an oversight system.

9. The network architecture of claim 7 further comprising a back-end local area network for remote monitoring of the honeypot systems.

10. The network architecture of claim 7 wherein the network address is an Internet Protocol address.
